(19) United States
(12) Patent Application Publication
(10) Pub. No.: US 2007/0275186 A1
(43) Pub. Date: Nov. 29, 2007

(54) Dye-Based Polarizing Filim

(75) Inventor: Toru ASHIDA, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 11/751,264

(22) Filed: May 21, 2007

(30) Foreign Application Priority Data
May 24, 2006 (JP) 2006-143560
Aug. 23, 2006 (JP) 2006-226398

(51) Int. Cl. C09K 19/00

(52) U.S. Cl. 428/1.31

(57) ABSTRACT

A polarizing film having uniformly low orthogonal transmittance in the wavelength range from 550 to 700 nm inclusive, and having excellent light resistance includes a dichroic dye containing a polyazo compound of the formula (I) and an azo compound of the formula (II):

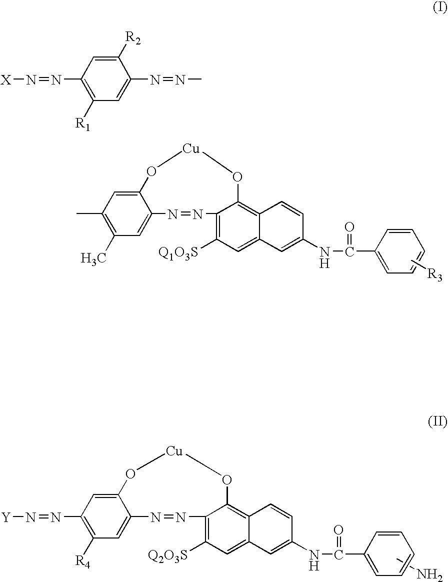

wherein, X represents a naphthyl group having 1 to 3 sulfo groups, Y represents a phenyl group having 1 to 2 sulfo groups, or a naphthyl group having 1 to 3 sulfo groups, X and Y optionally being substituted with at least one group selected from the group consisting of alkyl groups and alkoxy groups each having 1 to 6 carbon atoms, R1, R2 and R4 represent each independently a hydrogen atom, alkyl group or alkoxy group each having 1 to 6 carbon atoms, R3 represents an amino group or hydroxyl group, and Q1 and Q2 represent each independently a hydrogen atom, alkali metal, organic amine or ammonium.

### TECHNICAL FIELD

The present invention relates to a dye-based polarizing film containing a polyazo compound.

### BACKGROUND TECHNOLOGY

In-car displays such as car navigations and the like are used under environments irradiated with day light, and liquid crystal displays such as liquid crystal projectors, projection televisions and the like are used under environments irradiated with large light quantity, therefore, there are required polarizing films having excellent degree of polarization as in conventional films and, further, having excellent light resistance which shows little decrease in absorbance of a polarizing film even if irradiated for a long time with large light quantity under an environment of high temperature.

The polarizing film is produced, for example, by allowing a polarizing film substrate of a stretched oriented polyvinyl alcohol-based film to contain iodine or dye as a polarization element. Such an iodine-based polarizing film is inferior in durability against heat, thus, has a problem of deterioration of light resistance under high temperature conditions.

While, a dye-based polarizing film using a dye as a polarizer has more excellent durability against heat as compared with the iodine-based polarizing film, thus, used more and more recently.

Specifically, Example 1 in Patent Document 1 discloses a polarizing film having a polarizing film substrate containing a compound of the formula (I-1) as a dye, and exemplifies that its λmax (wavelength at which, when a polarizing film is irradiated with light, the transmittance of the light which is transmitted toward the orientation direction of the polarizing film is minimum. Applicable also in the following descriptions) gives 610 nm. Example 1 in Patent Document 2 discloses a polarizing film containing a compound of the formula (II-1) as a dye, and exemplifies that its λmax gives 616 nm.

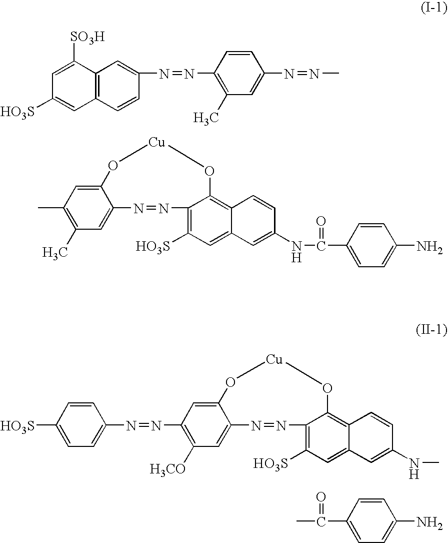

[Patent Document 1] Japanese Patent Application Laid-Open (JP-A) No. 2005-171231 Example 1

[Patent Document 2] JP-A No. 6-122831 Example 1

### DISCLOSURE OF THE INVENTION

When two polarizing films are superimposed so that orientation directions thereof cross at right angle (cross position) and there is leakage of a light of specific wavelength in a visible wavelength range, if the polarizing films are installed on a liquid crystal display, then, display of liquid crystal shows discoloration by leakage of a light of specific wavelength in dark condition (shifting from neutral color (neutral gray)). To prevent such a phenomenon, transmittance in cross position (orthogonal transmittance) in the visible range, particularly, in the wavelength range from 550 nm to 700 nm should be uniformly lowered, in two polarizing films.

Investigations by the present inventors have clarified that the orthogonal transmittance of a polarizing film having a polarizing film substrate containing only a compound (I-1) as a dichroic dye does not uniformly lower at from 550 to 700 nm, particularly at 700 nm, resultantly, manifesting light leakage. Also it has been clarified that the orthogonal transmittance of a polarizing film having a polarizing film substrate containing only a compound (II-1) as a dichroic dye does not uniformly lower at from 550 to 570 nm, manifesting light leakage, further, more improvement in light resistance being required.

The object of the present invention is to provide a polarizing film having a property that the orthogonal transmittance is uniformly low in the wavelength range from 550 to 700 nm including also 700 nm, and having excellent light resistance.

The present inventors have found that a polarizing film containing a certain kind of polyazo compound and a certain kind of azo compound can solve the problem as described above.

That is, the present invention provides the following [1] to [8].

[1] A polarizing film comprising a dichroic dye containing a polyazo compound of the formula (I) and an azo compound of the formula (II):

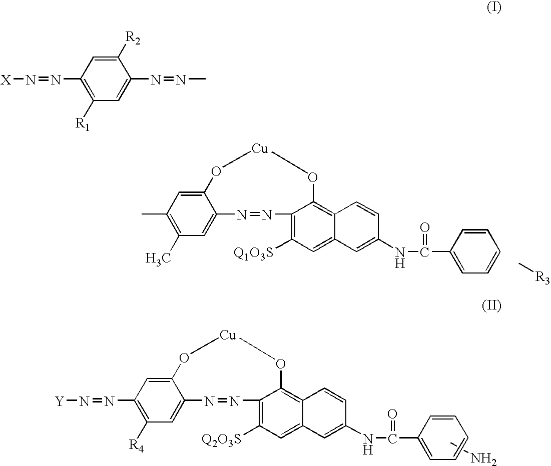

(wherein, X represents a naphthyl group having 1 to 3 sulfo groups, further, X may have at least one group selected from the group consisting of alkyl groups having 1 to 6 carbon atoms and alkoxy groups having 1 to 6 carbon atoms, Y represents a phenyl group having 1 to 2 sulfo groups, or a naphthyl group having 1 to 3 sulfo groups, Y may, further, have at least one group selected from the group consisting of alkyl groups having 1 to 6 carbon atoms and alkoxy groups having 1 to 6 carbon atoms, R¹, R² and R⁴ represent each independently a hydrogen atom, alkyl group having 1 to 6 carbon atoms or alkoxy group having 1 to 6 carbon atoms, R³ represents an amino group or hydroxyl group, and Q₁ and Q₂ represent each independently a hydrogen atom, alkali metal, organic amine or ammonium.).

[2] The polarizing film according to [1] wherein R¹ represents a hydrogen atom, methyl group or methoxy group.

[3] The polarizing film according to [1] or [2] wherein R² represents a hydrogen atom, methyl group or methoxy group.

[4] The polarizing film according to any one of [1] to [3] wherein R⁴ represents a hydrogen atom, methyl group or methoxy group.

[5] The polarizing film according to any one of [1] to [4], further comprising an organic dye other than the compound of the formula (I) and the compound of the formula (II) as the dichroic dye.

[6] The polarizing film according to [5] wherein the organic dye other than the compound of the formula (I) and the compound of the formula (II) is at least one organic dye selected from the group consisting of organic dyes represented by the following Color Index Generic Names:

C. I. Direct Yellow 12

C. I. Direct Yellow 28

C. I. Direct Yellow 44

C. I. Direct Orange 26

C. I. Direct Orange 39

C. I. Direct Orange 107

C. I. Direct Red 2

C. I. Direct Red 31

C. I. Direct Red 79

C. I. Direct Red 81

C. I. Direct Red 117

C. I. Direct Red 247.

[7] The polarizing film according to any one of [1] to [6] wherein the polarizing film is a polarizing film containing polyvinyl alcohol as a polarizing film substrate.

[8] A liquid crystal display having the polarizing film according to any one of [1] to [7].

### MODES FOR CARRYING OUT THE INVENTION

The present invention will be described below.

In the above-mentioned formula, X represents a naphthyl group having 1 to 3 sulfo groups. The naphthyl group may further have an alkyl group having 1 to 6 carbon atoms and/or an alkoxy group having 1 to 6 carbon atoms.

Here, examples of the alkyl group having 1 to 6 carbon atoms include a methyl group, ethyl group, propyl group and the like, and linear alkyl groups having 1 to 4 carbon atoms are preferable, a methyl group and an ethyl group are more preferable, a methyl group is particularly preferable. Examples of the alkoxy group having 1 to 6 carbon atoms include a methoxy group, ethoxy group, propoxy group and the like, and linear alkoxy groups having 1 to 4 carbon atoms are preferable, a methoxy group and an ethoxy group are more preferable, a methoxy group is particularly preferable.

The sulfo group may be a sulfonic group having a hydrogen atom, or a sulfonate obtained by substituting a hydrogen atom in a sulfonic group by an alkali metal, organic amine or ammonium. Here, examples of the alkali metal include lithium, sodium, potassium and the like. Examples of the organic amine include ethanolamine, alkylamine and the like. Of them, a sodium salt of a sulfo group is preferable since it has a tendency to be contained easily in a polarizing film substrate.

Examples of X as a naphthyl group having 1 to 3 sulfo groups include naphthyl groups having one sulfo group such as 5-sulfo-2-naphthyl, 6-sulfo-2-naphthyl, 7-sulfo-2-naphthyl, 8-sulfo-2-naphthyl, 4-sulfo-1-naphthyl, 5-sulfo-1-naphthyl, 6-sulfo-1-naphtyl, 7-sulfo-1-naphthyl and the like; naphthyl groups having two sulfo groups such as 1,5-disulfo-2-naphthyl, 6,8-disulfo-2-naphthyl, 4,8-disulfo-2-naphthyl, 5,7-disulfo-2-naphthyl, 3,6-disulfo-1-naphthyl, 3,6-disulfo-1-naphthyl, 4,6-disulfo-1-naphtyl and the like; and naphthyl groups having three sulfo groups such as 1,5,7-trisulfo-2-naphthyl, 3,6,8-trisulfo-2-naphthyl, 4,6,8-trisulfo-2-naphthyl and the like.

As X, preferable are naphthyl groups having 2 to 3 sulfo groups, and particularly preferable are 1,5-disulfo-2-naphthyl, 6,8-disulfo-2-naphthyl, 4,8-disulfo-2-naphthyl, 5,7-disulfo-2-naphthyl and 3,6-disulfo-2-naphthyl, from the standpoint of a dyeing property.

Y represents a phenyl group having 1 to 2 sulfo groups or a naphthyl group having 1 to 3 sulfo groups. Y may further have an alkyl group having 1 to 6 carbon atoms and/or an alkoxy group having 1 to 6 carbon atoms, and preferably, may have a linear alkyl group having 1 to 4 carbon atoms and/or a linear alkoxy group having 1 to 4 carbon atoms.

Here, the alkyl group having 1 to 6 carbon atoms, the alkoxy group having 1 to 6 carbon atoms and the naphthyl group having 1 to 3 sulfo groups represent the same meanings as described above.

Examples of the phenyl group having 1 to 2 sulfo groups optionally having an alkyl group having 1 to 6 carbon atoms and/or an alkoxy group having 1 to 6 carbon atoms include phenyl groups having one sulfo group such as 2-sulfophenyl, 3-sulfophenyl, 4-sulfophenyl, 2-methyl-4-sulfophenyl, 3-methyl-4-sulfophenyl and the like; and phenyl groups having two sulfo groups such as 2,4-disulfophenyl, 2,5-disulfophenyl and the like.

As Y, preferable are phenyl groups having one sulfo group and naphthyl groups having 2 to 3 sulfo groups, more preferable are 4-sulfophenyl, 1,5-disulfo-2-naphthyl, 6,8-disulfo-2-naphthyl, 4,8-disulfo-2-naphthyl, 5,7-disulfo-2-naphthyl and 3,6-disulfo-2-naphthyl, and among them, 4-sulfophenyl is particularly preferable, from the standpoint of a dyeing property.

R¹, R² and R⁴ represent each independently a hydrogen atom, alkyl group having 1 to 6 carbon atoms or alkoxy group having 1 to 6 carbon atoms, preferably a liner alkyl group having 1 to 4 carbon atoms or a liner alkoxy group having 1 to 4 carbon atoms. Here, the alkyl group having 1 to 6 carbon atoms and the alkoxy group having 1 to 6 carbon atoms represent the same meanings as described above.

R¹ and R² represent preferably a group selected from the group consisting of a hydrogen atom, methyl group and methoxy group, and R⁴ represents preferably a hydrogen atom, methyl group or methoxy group, more preferably a methyl group or methoxy group, particularly preferably a methoxy group.

R³ represents an amino group or hydroxyl group. The connecting position of R³ is usually ortho position or para position for a benzoylamino group, and preferably para position for a benzoylamino group.

Q₁ and Q₂ represent each independently a hydrogen atom, alkali metal, organic amine or ammonium. Here, examples of the alkali metal include lithium, sodium, potassium and the like, and examples of the organic amine include ethanolamine, alkylamine and the like. Of them, sodium is preferable since it has a tendency to be contained easily in a polarizing film substrate.

As the method of producing a compound of the formula (I), the following method and the like are exemplified.

First, a bisazo compound (III) of the formula (III):

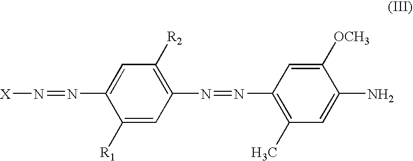

(wherein, X, R₁ and R₂ represent the same meanings as described above.).
is reacted with sodium nitrite in an acidic aqueous medium at 0 to 40° C., to perform diazotization.

The resultant diazo compound can be reacted with a compound of the formula (IV) in an aqueous medium at 0 to 40° C. and at pH 6 to 11 to obtain a compound of the formula (V).

Subsequently, into an aqueous solution containing a compound of the formula (V), a copper salt such as copper sulfate, copper chloride, copper acetate and the like, preferably, copper sulfate is added, and the mixture is heated at about 70 to 100° C. to produce a compound of the formula (I). Such a method and the like are mentioned. To the compound (I), a lithium salt such as lithium carbonate, lithium hydrogen carbonate and the like, a sodium salt such as sodium carbonate, sodium hydrogen carbonate and the like, a potassium salt such as potassium carbonate, potassium hydrogen carbonate and the like, or an amine such as ammonia, monoethanolamine, diethanolamine, monopropanolamine, pyridine and the like may further be added according to demands.

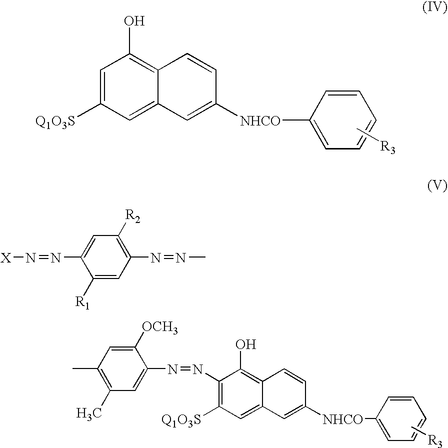

(wherein, X, R₁, R₂, R₃ and Q₁ represent the same meanings as described above.).

Examples of the compound of the formula (I) in the form of sodium salt include compounds of the following formulae (I-1) to (I-7).

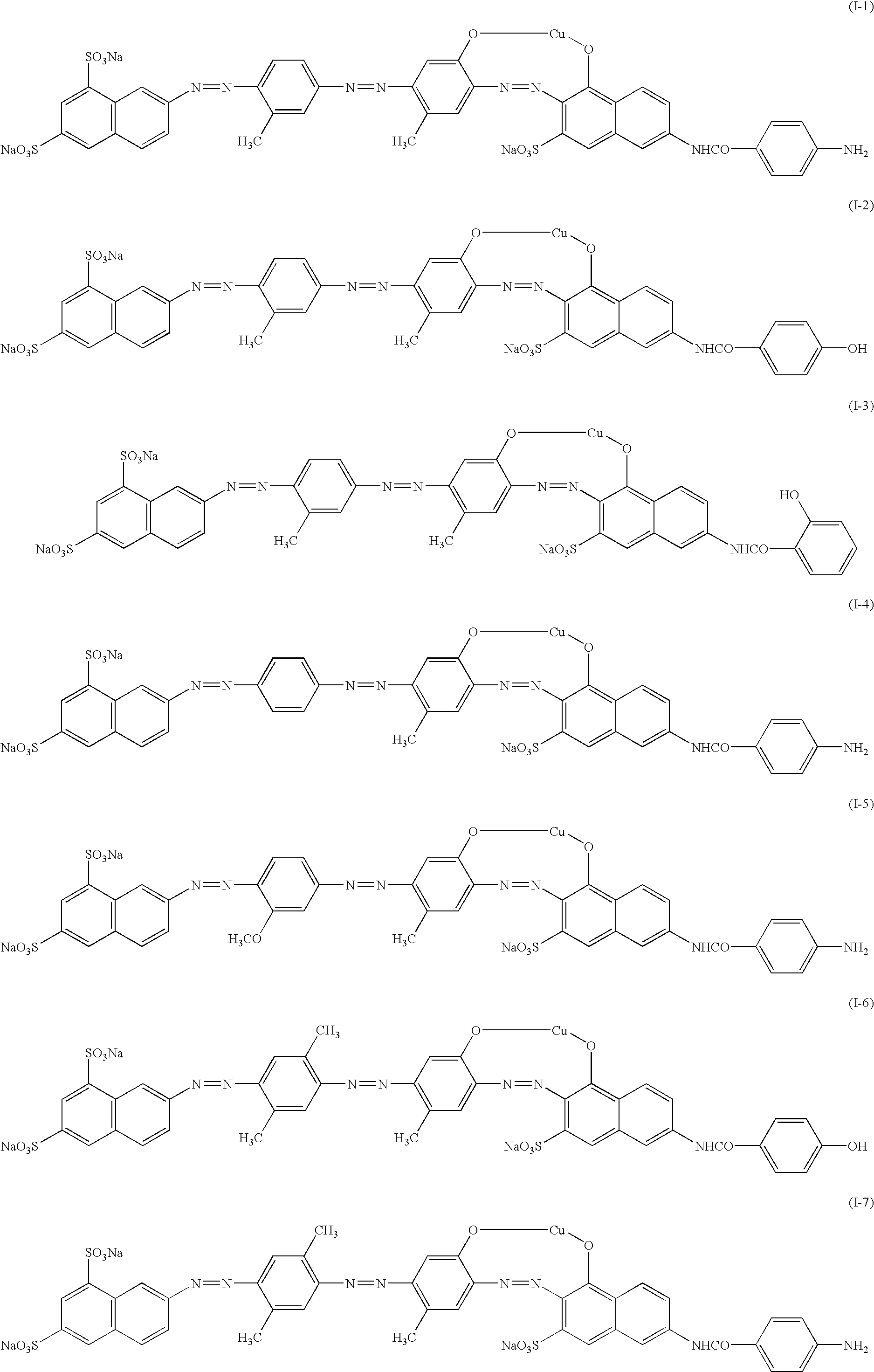

The method of producing a compound of the formula (II) may be advantageously carried out in the same manner as in the above-mentioned method of producing a compound (I) excepting that a compound of the formula (VI) is used instead of a compound of the formula (III).

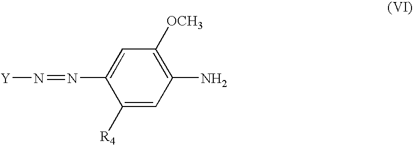

(wherein, Y and R₄ represent the same meanings as described above.).

Examples of the compound of the formula (II) in the form of sodium salt include compounds of the following formulae (II-1) to (II-7).

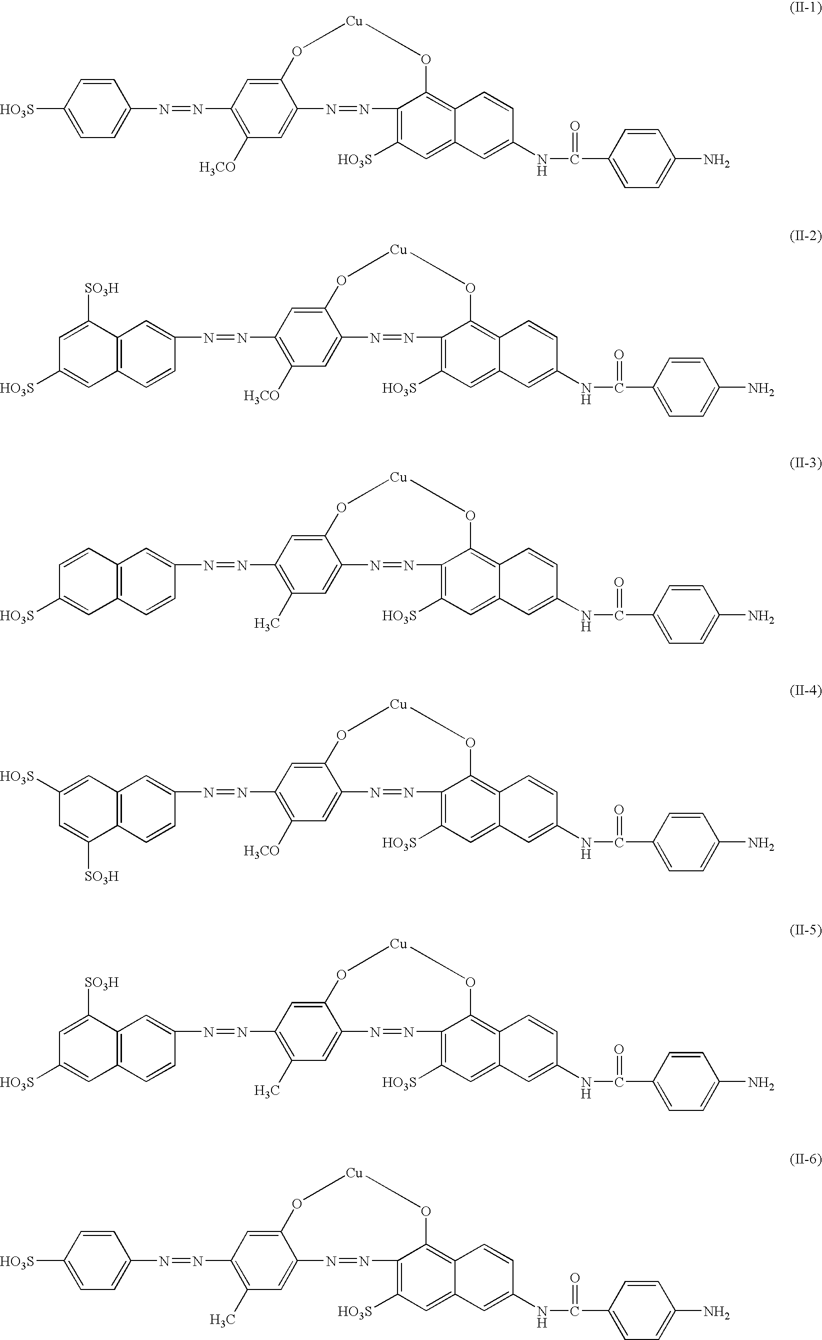

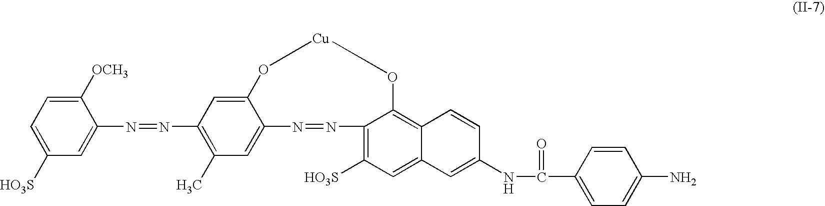

Regarding the use amounts of a compound of the formula (I) and a compound of the formula (II) to be used in the polarizing film of the present invention, the amount of the compound (II) is usually 0.1 to 100 parts by weight, preferably 0.5 to 100 parts by weight, more preferably 1 to 20 parts by weight based on 100 parts by weight of the compound (I). When the amount of the compound (II) is 0.1 part by weight or more, light leakage tends to decrease preferably, and when 100 parts by weight or less, light resistance tends to increase preferably.

The polarizing film of the present invention may be allowed to contain an organic dye other than the compound of the formula (I) and the compound of the formula (II) for improving a polarization performance even at wavelengths other than 550 to 700 nm.

Here, this organic dye is usually a dye of high dichroism other than the compound of the formula (I) and the compound of the formula (II), and preferably, a dye excellent in light resistance.

Specific examples of the organic dye include organic dyes represented by the following Color Index Generic Names. The organic dyes may be used singly or in combination of two or more.

C. I. Direct Yellow 12

C. I. Direct Yellow 28

C. I. Direct Yellow 44

C. I. Direct Orange 26

C. I. Direct Orange 39

C. I. Direct Orange 107

C. I. Direct Red 2

C. I. Direct Red 31

C. I. Direct Red 79

C. I. Direct Red 81

C. I. Direct Red 117

C. I. Direct Red 247.

Examples of the polarizing film substrate include substrate s made of polyvinyl alcohol-based resins, polyvinyl acetate resins, ethylene/vinyl acetate (EVA) resins, polyamide resins, polyester resins and the like.

Here, the polyvinylalcohol-based resins include polyvinyl alcohols which are partially or completely saponified substances of polyvinyl acetate; saponified substances of copolymers of vinyl acetate with other copolymerizable monomers (for example, olefins such as ethylene and propylene, unsaturated carboxylic acids such as crotonic acid, acrylic acid, methacrylic acid and maleic acid, unsaturated sulfonic acids, vinyl ethers and the like) such as saponified EVA resin and the like; polyvinylformal or polyvinylacetal obtained by modifying polyvinyl alcohol with an aldehyde, and the like.

As the polarizing film substrate, suitably used are films made of polyvinyl alcohol-based resins, particularly, films made of polyvinyl alcohol itself, from the standpoint of adsorptivity and orientation property of a dye.

As the method of producing a polarizing film, the following example is exemplified. First, a dye for polarizing film is dissolved in water so as to give a concentration of about 0.0001 to 10 wt % to prepare a dye bath. If necessary, a dyeing aid may be used, and for example, a method of using mirabilite in a concentration of 0.1 to 10wt % in a dye bath is suitable.

A polarizing film substrate is immersed in thus prepared dye bath, and dyeing is carried out. The dyeing temperature is preferably 40 to 80° C. Orientation of a dye is performed by stretching a polarizing film substrate before dyeing or a dyed polarizing film substrate. As the stretching method, for example, wet mode or dry mode stretching methods are mentioned.

For the purpose of improving beam transmittance, degree of polarization and light resistance of a polarizing film, a post treatment such as a boric acid treatment and the like may be performed. In the boric acid treatment, a boric acid aqueous solution so prepared as to give a concentration of 1 to 15 wt %, preferably 5 to 10 wt % is usually used, and a polarizing film substrate is usually immersed in the aqueous solution in the temperature range from 30 to 80° C., preferably 50 to 80° C., varying depending on the kind of the polarizing film substrate to be used and the kind of the dye to be used. Further, if necessary, a fix treatment may also be conducted additionally in an aqueous solution containing a cationic polymer compound.

The orthogonal transmittance of thus obtained polarizing film is a value obtained by multiplying the transmittance of a light of which vibration direction is parallel to the polarizing film (hereinafter, referred to as MD) by the transmittance of a light of which vibration direction is vertical to the polarizing film (hereinafter, referred to as TD) and dividing the value by 100, and when this value is smaller, the orthogonal transmittance at the measurement wavelength is smaller and light leakage at the wavelength is smaller.

The uniformly low orthogonal transmittance means that when MD and TD are measured every 10 nm and orthogonal transmittances at respective wavelengths are calculated, and the average value of the orthogonal transmittance in the measuring wavelength range is calculated, then, the average value is a value near 0%, and specifically, the average orthogonal transmittance between 550 to 700 nm is preferably 0.05% or less, more preferably 0.01% or less. When the orthogonal transmittance is uniformly low, light leakage is small and discoloration in display of liquid crystal is small under dark condition.

The polarizing film of the present invention is excellent in light resistance, and additionally, the orthogonal transmittance at 550 to 700 nm is uniformly low, and the orthogonal transmittance at 700 nm gives a low value of 0.1% or less, thus, discoloration of display of liquid crystal under dark condition becomes small.

The polarizing film of the present invention shows orthogonal transmittance which is uniformly low in the wavelength range from 550 to 700 nm including alto 700 nm, and when the polarizing film is installed on a liquid crystal display, discoloration of display of liquid crystal due to light leakage in the visible region (color leakage) is small under dark condition. Also because of excellent light resistance, the polarizing film is suitable for display applications such as, for example, car navigations, liquid crystal projectors, projection televisions and the like.

### EXAMPLES

The present invention will be illustrated further in detail based on examples below, however, it is needless to say that the present invention is not limited to the examples at all. “%” and “parts” in examples and comparative examples are % by weight and parts by weight unless otherwise stated. Salts of compounds are expressed in the form of sodium salt.

### Example 1

### Production Example of compound (I-1)

170 parts of a bisazo compound of the formula (III-1):

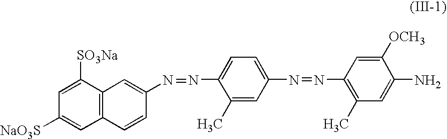

and 30 parts of sodium nitrite were added to 1500 parts of water, then, 120 parts of 35% hydrochloric acid was added at 20 to 30° C. and the mixture was stirred for 2 hours, to perform diazotization. Excess sodium nitrite was removed by adding sulfamic acid, to obtain diazo liquid.

Next, the above-mentioned diazo liquid was added over 1 hour into liquid containing a compound of the formula (IV-1):

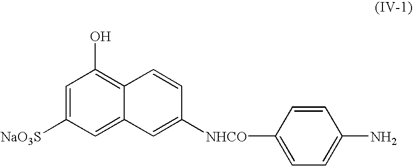

while maintaining pH at 7 using an aqueous sodium carbonate solution.

After completion of addition, the mixture was stirred further for 1 hour, to obtain a polyazo compound of the above-mentioned formula (V-1). λmax of this polyazo compound was 565 nm in an aqueous medium.

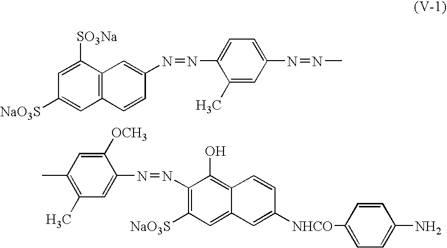

25 parts of a compound of the formula (V-1) was added to 500 parts of water, and 6 parts of anhydrous copper sulfate and 8 parts of monoethanolamine were added and the mixture was heated up to 95° C., and reacted for 12 hours. Then, the mixture was cooled down to 30° C., then, 35% hydrochloric acid was added to give pH 7, then, salting out is performed using sodium chloride, and the deposited crystal was filtrated, to obtain a compound of the formula (I-1). λmax of the compound (I-1) was 598 nm in an aqueous medium.

### Production Example of Compound (II-1)

A compound of the formula (II-1) was obtained in the same manner as described above except that a compound of the formula (VI-1) was used instead of the bisazo compound of the formula (III-1).

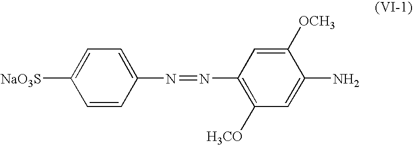

### Production Example of Polarizing Film

A polyvinyl alcohol film [Kuraray Vinylon #7500, manufactured by Kuraray Co., Ltd.] having a thickness of 75 μm was mono-axially stretched to five-fold, to obtain a polarizing film substrate . This polyvinyl alcohol film was, while being kept under tension state, immersed in an aqueous solution of 73° C. containing 0.175% of the above-mentioned compound (I-1) and 0.035% of the above-mentioned compound (II-1) as polarizing film dyes, and containing 0.02% of mirabilite as a dyeing aid. Next, the polarizing film was immersed for 5 minutes in a 7.5% boric acid aqueous solution of 78° C., then, taken out, washed with water of 20° C. for 20 seconds, and dried at 50° C. to obtain a polarizing film. λmax of the resultant polarizing film was 620 nm (SHIMADZU UV2450, spectrophotometer [manufactured by Shimadzu Corporation]).

The orthogonal transmittance in the wavelength range of 550 nm to 700 nm was measured by the same spectrophotometer, and the results were shown in Table 1. When calculation was performed while hypothesizing the orthogonal transmittance at the detection limitation or lower to be 0, the average orthogonal transmittance was 0.004%, and light leakage in this wavelength range was extremely small. The orthogonal transmittance at 700 nm was 0.04%, and light leakage at 700 nm was small.

TABLE 1

| | | Comparative | Comparative |
|---|---|---|---|
| | Example 1 | Example 1 | Example 2 |
| Wavelength | Orthogonal transmittance | | |
| 550 | 0.01 | 0.13 | 0.71 |
| 560 | <0.001 | 0.04 | 0.28 |
| 570 | <0.001 | 0.01 | 0.09 |
| 580 | <0.001 | <0.001 | 0.03 |
| 590 | <0.001 | <0.001 | 0.01 |
| 600 | <0.001 | <0.001 | <0.001 |
| 610 | <0.001 | <0.001 | <0.001 |
| 620 | <0.001 | <0.001 | <0.001 |
| 630 | <0.001 | <0.001 | <0.001 |
| 640 | <0.001 | <0.001 | <0.001 |
| 650 | <0.001 | <0.001 | <0.001 |
| 660 | <0.001 | 0.01 | <0.001 |
| 670 | <0.001 | 0.02 | <0.001 |
| 680 | <0.001 | 0.09 | <0.001 |
| 690 | 0.01 | 0.38 | 0.1 |
| 700 | 0.04 | 1.32 | 0.04 |
| Average | 0.004 | 0.125 | 0.073 |
| orthogonal | | | |
| transmittance | | | |
| at 550 to 700 nm | | | |

The resultant polarizing film was irradiated with light at 100° C. for 120 hours by a high pressure mercury lamp of a brilliance of 405 mW/cm₂ (red light) situated at a position 25 cm remote from the polarizing film, then, the value of ΔA(%) was 4.2%, and light resistance against exposure under high temperature for a long period of time was also excellent. When the value of absorbance at 0 hour is represented by A(0) and the value of absorbance after 96 hours is represented by A(96), ΔA(%) is defined as described below.

ΔA(%)=((A(0)−A(96))/A(0))×100

### When ΔA is smaller, light resistance is more excellent.

### Comparative Example 1

A polarizing film was obtained in the same manner as in Example 1 excepting that only the compound (I-1) was used in an amount of 0.2% as the polarizing film dye to be contained in an aqueous solution into which the stretched polarizing film substrate was immersed. λmax of the resultant polarizing film was 610 nm.

The orthogonal transmittance in the wavelength range of 550 nm to 700 nm was shown in Table 1. When calculation was performed while hypothesizing the orthogonal transmittance at the detection limitation or lower to be 0, the average orthogonal transmittance was 0.125%, and light leakage in this wavelength range was large. The orthogonal transmittance at 700 nm was 1.32%, and light leakage at this wavelength was large.

ΔA was measured in the same manner as in Example 1, then, the value of ΔA was 4.0%, meaning light resistance equivalent to that of the present invention.

### Comparative Example 2

A polarizing film was obtained in the same manner as in Example 1 excepting that only the compound (II-1) was used in an amount of 0.2% as the polarizing film dye to be contained in an aqueous solution into which the stretched polarizing film substrate was immersed. λMax of the resultant polarizing film was 620 nm.

The orthogonal transmittance in the wavelength range of 550 nm to 700 nm was shown in Table 1. When calculation was performed while hypothesizing the orthogonal transmittance at the detection limitation or lower to be 0, the average orthogonal transmittance was 0.073%, and light leakage in this wavelength range was somewhat large. The orthogonal transmittance at 700 nm was 0.04%, and light leakage at this wavelength was small.

ΔA was measured in the same manner as in Example 1, then, the value of ΔA was 6.0%, meaning light resistance inferior to that of the present invention.

### INDUSTRIAL APPLICABILITY

The polarizing film of the present invention can be used suitably for liquid crystal displays such as car navigations, liquid crystal projectors, projection televisions and the like.

1. A polarizing film comprising a dichroic dye containing a polyazo compound of the formula (I) and an azo compound of the formula (II): 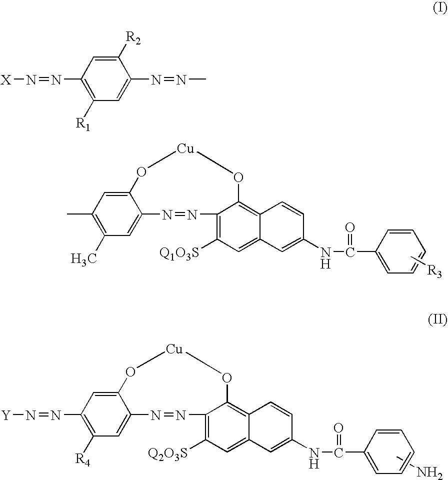
(wherein, X represents a naphthyl group having 1 to 3 sulfo groups, further, X may have at least one group selected from the group consisting of alkyl groups having 1 to 6 carbon atoms and alkoxy groups having 1 to 6 carbon atoms, Y represents a phenyl group having 1 to 2 sulfo groups, or a naphthyl group having 1 to 3 sulfo groups, Y may, further, have at least one group selected from the group consisting of alkyl groups having 1 to 6 carbon atoms and alkoxy groups having 1 to 6 carbon atoms, R¹, R² and R⁴ represent each independently a hydrogen atom, alkyl group having 1 to 6 carbon atoms or alkoxy group having 1 to 6 carbon atoms, R³ represents an amino group or hydroxyl group, and Q₁ and Q₂ represent each independently a hydrogen atom, alkali metal, organic amine or ammonium.).

2. The polarizing film according to claim 1 wherein R¹ represents a hydrogen atom, methyl group or methoxy group.

3. The polarizing film according to claim 1 wherein R² represents a hydrogen atom, methyl group or methoxy group.

4. The polarizing film according to claim 1 wherein R⁴ represents a hydrogen atom, methyl group or methoxy group.

5. The polarizing film according to claim 1, further comprising an organic dye other than the compound of the formula (I) and the compound of the formula (II) as the dichroic dye.

6. The polarizing film according to claim 5 wherein the organic dye other than the compound of the formula (I) and the compound of the formula (II) is at least one organic dye selected from the group consisting of organic dyes represented by the following Color Index Generic Names:
C. I. Direct Yellow 12
C. I. Direct Yellow 28
C. I. Direct Yellow 44
C. I. Direct Orange 26
C. I. Direct Orange 39
C. I. Direct Orange 107
C. I. Direct Red 2
C. I. Direct Red 31
C. I. Direct Red 79
C. I. Direct Red 81
C. I. Direct Red 117
C. I. Direct Red 247.

7. The polarizing film according to claim 1 wherein the polarizing film is a polarizing film containing polyvinyl alcohol as a polarizing film substrate.

8. A liquid crystal display having the polarizing film according to claim 1.
